(19) United States
(12) Patent Application Publication
(10) Pub. No.: US 2007/0121740 A1
(43) Pub. Date: May 31, 2007

(54) Selective attenuation in spectral notching

(75) Inventor: Timothy L. Gallagher, Encinitas, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/290,140

(22) Filed: Nov. 29, 2005

(51) Int. Cl. H04K 1/10

(52) U.S. Cl. 375/260

(57) ABSTRACT

Processing data is disclosed. Information associated with a notch frequency spectrum is obtained. A notch signal level, associated with the notch frequency spectrum, is suppressed. A second frequency spectrum is determined based at least in part on the information associated with the notch frequency spectrum. Data associated with the second frequency spectrum is attenuated, where the notch signal level is based at least in part on the attenuated data.

### BACKGROUND OF THE INVENTION

A wireless device occasionally creates a spectral notch in a transmitted signal. In one scenario, two wireless devices transmit in the vicinity of one another. To avoid interfering, one of the devices may create a spectral notch in its transmitted signal. The frequency spectrum of the spectral notch may approximate the frequency spectrum used by the other device.

However, improvements to enable a spectral notch with a particular attenuation or bandwidth may be relatively difficult to design or expensive to build. One example component that may be expensive or difficult to improve is an image rejection mixer. Techniques to create a spectral notch that alleviate or eliminate some of these issues would be useful.

### BRIEF DESCRIPTION OF THE DRAWINGS

Various embodiments of the invention are disclosed in the following detailed description and the accompanying drawings.

FIG. 1A is a diagram illustrating an embodiment of contributions from two frequencies to the notch signal level at a notch frequency.

FIG. 1B is a diagram illustrating an embodiment of a reduced, unintentional contribution to the notch signal level of a notch frequency.

FIG. 2 is a flowchart illustrating an embodiment of attenuating data associated with an unintended contributor to reduce its contribution to a notch signal level.

FIG. 3 is a system diagram illustrating an embodiment of a wireless device that selectively attenuates data.

FIG. 4 is a block diagram illustrating an embodiment of a selectively attenuating baseband.

FIG. 5 is a block diagram illustrating an embodiment of a radio transmitter that performs a series of frequency related processing.

FIG. 6 is a diagram illustrating an embodiment of signal levels transmitted by a wireless device that selectively attenuates data.

FIG. 7 is a diagram illustrating an embodiment of signal levels transmitted by a wireless device that selectively attenuates data to avoid a notch frequency spectrum in a middle band.

FIG. 8 is a block diagram illustrating an embodiment of a radio transmitter that uses a switch to select a local oscillator.

FIG. 9 is a diagram illustrating an embodiment of signal levels transmitted by a wireless device that selectively attenuates data associated with certain subcarriers for all bands.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced-according to the claims without some or all of these specific details. For the purpose of clarity, technical material that is known in the technical fields related to the invention has not been described in detail so that the invention is not unnecessarily obscured.

Processing data is disclosed. Information associated with, a notch frequency spectrum is obtained. A notch signal level is suppressed over the notch frequency spectrum. A second frequency spectrum is determined based on the obtained information. In some embodiments, the signal level of the second frequency spectrum affects the notch signal level, but not by design. Data associated with the second frequency spectrum is attenuated. For example, the data may be attenuated by clipping or scaling the data. In some embodiments, this is performed prior to an Inverse Fast Fourier Transform (IFFT). The notch signal level is based at least in part on the attenuated data.

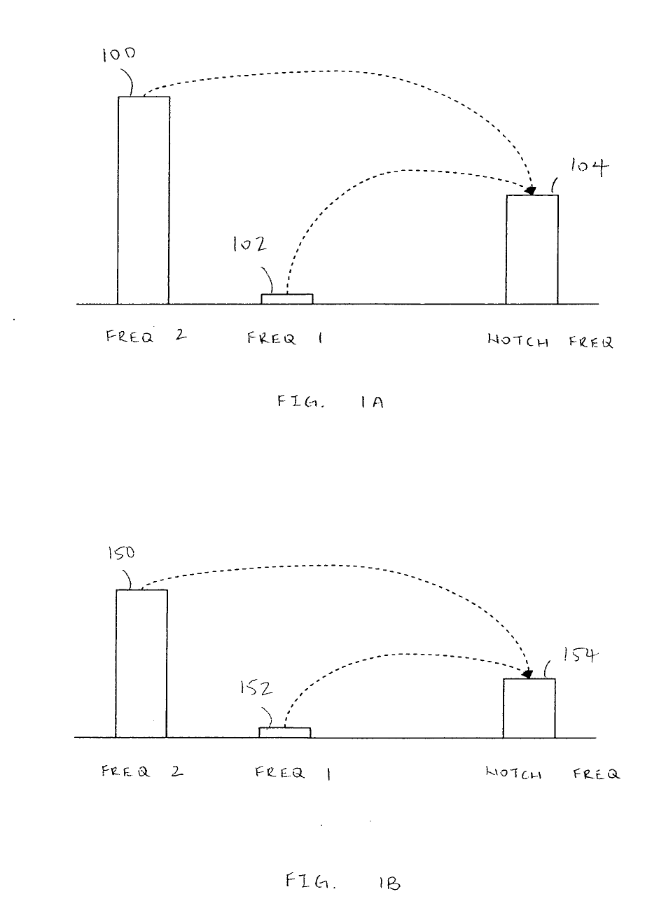

FIG. 1A is a diagram illustrating an embodiment of contributions from two frequencies to the notch signal level at a notch frequency. In the example shown, a WiMedia ultrawideband (UWB) wireless device is transmitting a signal and wants to suppress its transmitted signal in the notch frequency spectrum. A UWB device uses one or more of 14 bands, each of which is 528 MHz wide with center frequencies spanning from approximately 3.4 MHz to 10.3 MHz. In the one or more bands used by the UWB device, another wireless device may be operating. The other device may be a narrowband wireless device, such as an IEEE 802.11 (WiFi) or an IEEE 802.16 (WiMax) device. Other wireless devices may use bands with widths on the order of 10 to 20 MHz. To avoid interfering with the other device, the UWB device may define a notch frequency in which the UWB device suppresses its transmitted signal (i.e., reduces the signal level in the notch frequency spectrum). The notch frequency spectrum may approximately match the other wireless device's band.

The height of each block shown represents the maximum transmit signal level associated with that frequency spectrum. Since the UWB wireless device wishes to suppress transmissions in the notch frequency spectrum, the height of notch signal level 104 is relatively low. The amount of suppression for notch signal level 104 may be quantified and designers of wireless devices may have a desired suppression level of −30 dB. The desired suppression level may be mandated by a regulatory agency or a wireless specification, such as the WiMedia specification. To account for differences across manufactured devices, the desired suppression level may include some margin.

Information transmitted in the notch frequency spectrum (and thus, notch signal level 104) is designed to be based on information in frequency 1. Frequency 1 is associated with the notch frequency and may be referred to as an intended contributor. Frequency 1 and the notch frequency may represent the same frequency at different points in the transmit path of a wireless device. Frequency 1 may represent a point in baseband processing prior to an Inverse Fast Fourier Transform. The notch frequency spectrum may represent frequency 1 on-air after any remaining processing in the baseband and radio. Between the points represented by frequency 1 and the notch frequency spectrum, a UWB transmitter may frequency shift a transmit signal to an intermediate frequency spectrum, and then frequency shift from the intermediate frequency to the on-air radio frequency. To suppress notch signal level 104, frequency 1 may not necessarily be used to transmit data, and signal level 102 may be low.

In addition to frequency 1, one or more other frequencies may contribute to notch signal level 104. Some portion of signal level 100 in frequency 2 contributes to notch signal level 104. Frequency 2 and frequency 1 may correspond to the same point in a transmit path. Frequency 2 does not contribute to notch signal level 104 by design. Contributions from signal level 100 in frequency 2 may result from non-ideal components. Frequencies that are not designed to contribute to the notch signal level but do so are implementation dependent. Different implementations of the wireless device result in different frequencies unintentionally contributing to notch signal level 104. In particular, the implementation of the radio may determine which frequencies unintentionally contribute to the notch signal level. Such frequencies may be referred to as unintended contributors.

To reduce the contribution to notch signal level 104 from signal level 100 in frequency 2, data associated with frequency 2 may be attenuated. The following figure illustrates an example.

FIG. 1B is a diagram illustrating an embodiment of a reduced, unintentional contribution to the notch signal level of a notch frequency. In the example shown, the same UWB device of the previous figure is used, except that data associated with frequency 2 is attenuated. Signal level 150 in frequency 2 illustrates the maximum transmit signal level associated with frequency 2 and is less than signal level 100. Signal level 152 and signal level 102 have the same maximum transmit signal level. Notch signal level 154 is less than notch signal level 104. Further attenuating data associated with frequency 2 may further suppress the notch signal level 154.

Frequency 2 may be used to carry information even though data associated with frequency 2 is attenuated. Each of the bands defined in the WiMedia UWB specification have 100 subcarriers that are used to transmit data. The subcarriers are non-overlapping frequencies within a band and frequency 2 may comprise of one or more subcarriers.

In some cases, attenuating data associated with an unintended contributor may be sufficient to achieve a desired suppression level for the notch signal level. In other cases, other improvements are used in combination with attenuating data; these other improvements may not need to contribute as much towards the desired suppression level as they would without attenuating data. For example, current image rejection mixers may not need to be improved as much. Image rejection mixers are in many wireless devices and are used to limit contributions from unintended contributors. Improvements to image rejection mixers may be easier to design and/or less expensive to manufacture than if image rejection mixers are solely relied upon to achieve a desired suppression level. Designers may have a goal of −30 dB suppression in the notch frequency spectrum. If −10 dB of suppression is achieved by attenuating data from unintended contributors, only −20 dB of additional suppression remains to be achieved.

In some embodiments, a component other than an image rejection mixer is improved to achieve a desired suppression level. Other devices that may affect the notch signal level and may be improved to achieve a desired suppression level or bandwidth include: the local oscillator and filters. These devices may not need to be improved as much as they otherwise would be.

Ideally, a local oscillator contains only one frequency—however in practice, there are other frequencies present and the radio design reduces these un-intended frequencies to prevent signal emissions at frequencies other than the desired frequency. Spurious signals can originate from many sources including un-intended coupling between different circuit elements, amplifier non-linearity, power supply coupling, etc.

Filters are often used to reduce emissions at unwanted frequencies. An example includes the images created by digital to analog converters (DACs). The cost of a filter implementation is driven by the required attenuation, which in some cases could be reduced by using the methods described in this application.

The particular frequencies that are unintended contributors depend upon the implementation of the wireless device. Examples of unintended contributors are presented in the context of the example implementations. Other implementations may result in different frequencies unintentionally contributing to the notch signal level. In some cases, there may be multiple unintended contributors and some unintended contributors may contribute to the notch signal level more than others. Similarly, the positions in the above figures do not necessarily indicate relative frequency values. Although frequency 2 is located to the left of frequency 1, frequency 2 is not necessarily less than frequency 1. There may be additional frequencies used by a wireless device that do not affect the notch frequency that are not attenuated.

In some embodiments, a wireless device that selectively attenuates data is not an UWB device. A variety of wireless devices may selectively attenuate data to assist in creating a spectral notch in a transmitted signal. Although some of the presented embodiments may describe UWB systems, in some embodiments other devices such as Bluetooth devices, narrowband wireless devices, and mobile phones attenuate data to create a spectral notch.

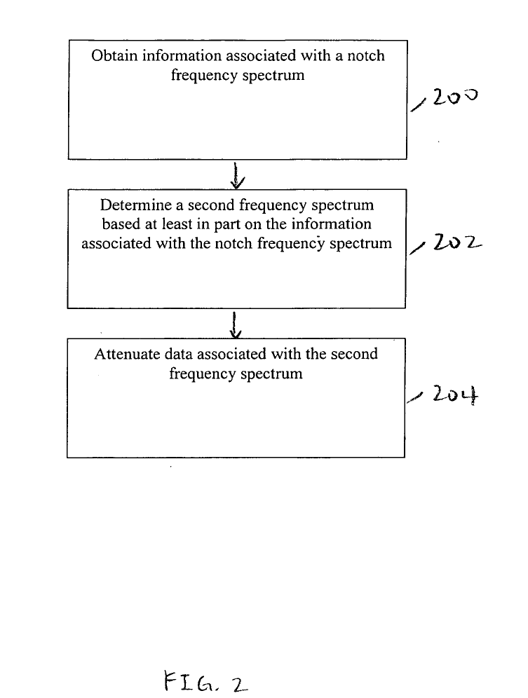

FIG. 2 is a flowchart illustrating an embodiment of attenuating data associated with an unintended contributor to reduce its contribution to a notch signal level. In the example shown, the process may be performed by a wireless device suppressing a signal level in a notch frequency spectrum. The notch frequency spectrum may be a band used by another wireless device and the wireless device may wish to avoid interfering with the other wireless device. Or, emissions in certain frequencies may be regulated to be below a required level in certain parts of the world (for example some frequencies are used for Radio Astronomy in Japan). Outside of the notch frequency spectrum, the transmitted signal may be unsuppressed.

At 200, information associated with a notch frequency spectrum is obtained. The information obtained describes the frequency spectrum of the notch frequency spectrum and may be communicated in a variety of ways. (f_{low}, f_{high}), (f_{center}, bandwidth), and (band 10, subcarriers 3-5) are some examples. The notch frequency spectrum may be described explicitly or implicitly.

In one example, the notch frequency spectrum is described by band and subcarrier. A wireless device rotates through a sequence of (first band, second band, third band) when transmitting. The information obtained at 200 may include (first band, subcarriers 2 and 3) and (third band, subcarrier −4). Other wireless devices are present in the first and third bands at the specified subcarriers, but the second band is unused by other devices. Information obtained at 200 may be obtained from another device or a component within the wireless device associated with detecting other wireless devices.

A second frequency spectrum based at least in part on the information associated with the notch frequency spectrum is determined at 202. The second frequency spectrum may be an unintended contributor to the signal level of the notch frequency spectrum. In some embodiments, a lookup table is used to determine the second frequency spectrum. In some embodiments, a component is designed to calculate the value of second frequency spectrum using the value of the notch frequency spectrum as an input. The second frequency spectrum may be described by subcarrier and/or band. If 100 subcarriers in a band are indexed −50 to −1 and 1 to 50, step 202 may output the appropriate subcarrier indices.

Data associated with the second frequency spectrum is attenuated at 204. This data affects the notch signal level and is attenuated to reduce the contribution to the notch signal level. Data may be attenuated in variety of ways, for example by clipping or scaling. The attenuation level may be programmable and a memory device may store the degree to which the data is attenuated, such as a ceiling value or a scaling factor.

Attenuating data associated with the second frequency spectrum may be performed prior to an IFFT in a baseband. An IFFT performs frequency to time domain conversion. Data associated with the second frequency spectrum may be attenuated and the attenuated data may be passed to the IFFT.

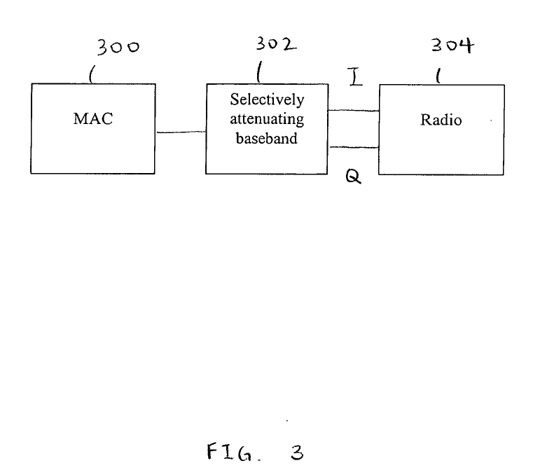

FIG. 3 is a system diagram illustrating an embodiment of a wireless device that selectively attenuates data. In the example shown, the device is a WiMedia UWB device that suppresses a transmitted signal in a notch frequency spectrum. Data to be transmitted is passed from Media Access Controller (MAC) 300 to baseband 302. Baseband 302 processes the digital data from MAC 300 and generates I and Q signals. Baseband 302 selectively attenuates data associated with certain frequencies. Intended contributors to the notch frequency are not used to transmit data. Data associated unintended contributors are attenuated by baseband 302. The I and Q signals produced by baseband 302 are passed to radio 304.

Radio 304 frequency shifts the I and Q signals to the appropriate band and transmits the frequency shifted signal. Before frequency shifting to the on-air band, radio 304 may frequency shift the I and Q signals to an intermediate frequency. The signal transmitted by radio 304 is suppressed within the notch frequency spectrum. Outside of the notch frequency spectrum the transmitted signal may be unsuppressed.

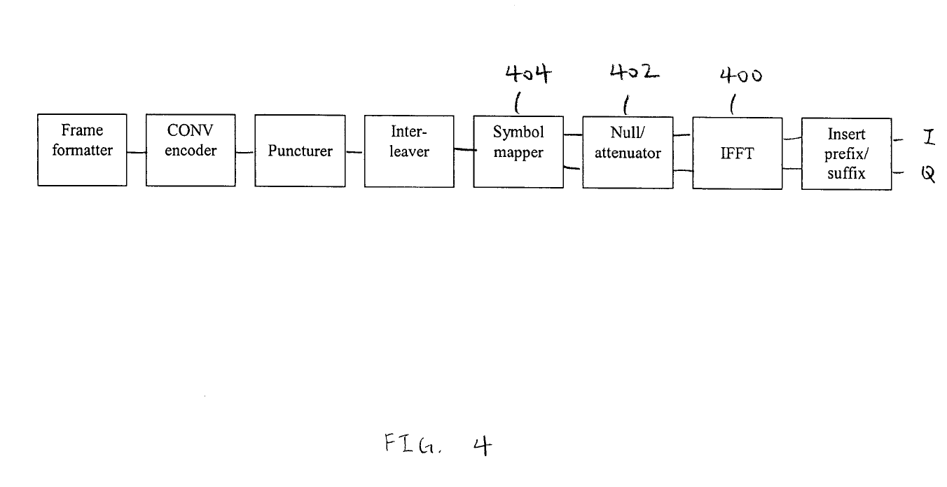

FIG. 4 is a block diagram illustrating an embodiment of a selectively attenuating baseband. In the example shown, the baseband may be used to implement baseband 302. Inverse Fast Fourier Transform (IFFT) 400 performs frequency to time domain conversion. IFFT 400 may be a 128-point transform, corresponding to 128 subcarriers in a band. Of the 128 subcarriers, 100 may be used to transmit data and some of the others may be used for overhead information.

Null and attenuation block 402 selectively nulls and attenuates data associated with certain subcarriers. Subcarriers that are intended contributors to the notch frequency spectrum are not used to transmit data. A null value is passed to IFFT 400 by null and attenuation block 402 for inputs that correspond to those subcarriers. Null and attenuation block 402 may discard data intended for these subcarriers or may buffer the data and transmit it in subsequent subcarriers.

In some embodiments, the notch signal level only needs to be attenuated a few dB. In such cases, data may be transmitted in subcarriers that are intended contributors. Rather than using a null value for these subcarriers, null and attenuation block 402 may attenuate the associated data. Data in unintended subcarriers may be attenuated to a lesser degree or not at all.

Data associated with subcarriers that are unintended contributors are attenuated by null and attenuation block 402. Attenuation may be performed by clipping or scaling the data. Parameters associated with attenuation, such as a scaling factor or a ceiling level, may be programmable. Data that not associated with either intended contributors or unintended contributors may be passed unmodified from symbol mapper 404 to IFFT 400.

Null and attenuation block 402 receives constellation symbols from symbol mapper 404. WiMedia UWB devices use Quadrature Phase Shift Keying (QPSK) or Dual Carrier Modulation (DCM) to modulate data. Constellation symbols generated by the selected modulation technique are transmitting in subcarriers and are selectively modified by null and attenuation block 402.

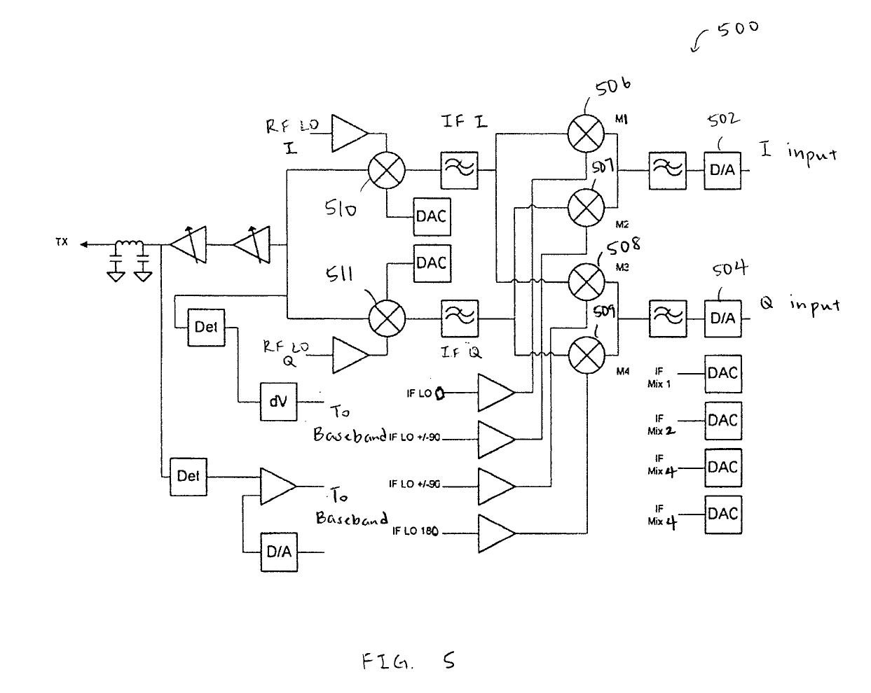

FIG. 5 is a block diagram illustrating an embodiment of a radio transmitter that performs a series of frequency related processing. In the example shown, radio transmitter 500 is included in the transmit portion of radio 304. Radio transmitter 500 is configured to support Time Frequency Interleaving (TFI) defined by the WiMedia specification. In TFI mode, a device alternates between multiple bands when transmitting. WiMedia UWB devices transmit frames comprising of symbols. The first symbol may be transmitted in a first band, the second symbol in a second band, and the third symbol in a third band. The sequence of bands is repeated to transmit the entire frame. TFI is may also be referred to as band hopping.

To support band hopping, the signals I input and Q input from a baseband are frequency shifted to an intermediate frequency, and then shifted to the on-air radio frequency. I input and Q input are passed to digital to analog converters 502 and 504, respectively. The analog I and Q signals are then processed by mixers 506-509 to frequency shift the analog I and Q signals to an intermediate frequency. Depending upon the phases of the intermediate frequency (IF) local oscillator (LO) signals passed to mixers 507 and 508, the analog I and Q signals are shifted into one of three intermediate frequencies. The IF LO operates at 528 MHz, which corresponds to the width of a WiMedia band. When a symbol is transmitted on the first band, the phases of the IF LO signals passed to mixers 507 and 508 are set to values that cause the analog I and Q signals to be frequency shifted to an intermediate frequency corresponding to the first band. To transmit symbols on the second and third bands, the phase values are appropriately changed between symbols. The phase settings passed to mixers 507 and 508 therefore select the appropriate band during band hopping.

The output from mixers 506 and 508 and mixers 507 and 509 are respectively combined. The first combination produces an intermediate frequency (IF) I signal and the second produces an IF Q signal. The IF I and Q signals are mixed with the output of a radio frequency (RF) local oscillator (LO) to generate the on-air radio frequency signals. IF I signal is passed to mixer 510 and IF Q signal is passed to mixer 511. The RF LO operates at the center frequency of the middle band used in band hopping. If bands 1-3 of the 14 bands are used, the center frequencies are 3.432 MHz, 3.960 MHz, and 4.488 MHz, respectively. RF LO generates a signal at 3.960 MHz. Since the IF signals have been frequency shifted to an appropriate intermediate frequency for band hopping, the RF LO does not change frequencies after each symbol during band hopping. The outputs from mixers 510 and 511 are combined, amplified, and transmitted.

The input I and Q signals passed to radio transmitter 500 are generated using data that is attenuated at subcarriers that are unintended contributors to the notch frequency. The frequencies that are unintended contributors may depend on the radio implementation. The following figures illustrate unintended contributors for the example radio implementation.

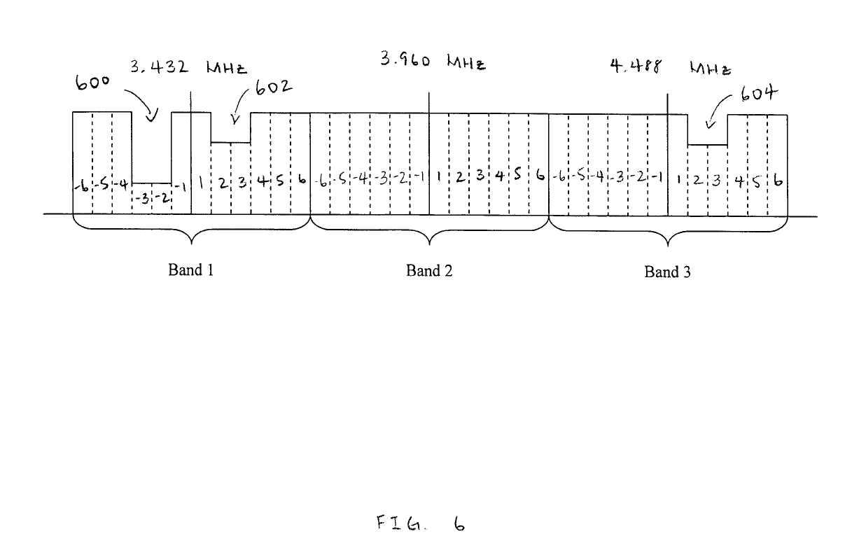

FIG. 6 is a diagram illustrating an embodiment of signal levels transmitted by a wireless device that selectively attenuates data. In the example shown, the transmitting wireless device includes radio transmitter 500 and performs band hopping over three bands. For each symbol, one of the three bands is used and thus the illustrated frequency spectrum is not a snapshot in time. A first symbol is transmitted in band 1, a second symbol is transmitted in band 2, and a third symbol is transmitted in band 3. Each band is 528 MHz wide and 12 subcarriers are shown in each band. There may be other subcarriers in addition to the 12 shown per band.

Notch frequency spectrum 600 includes subcarriers −3 and −2 in band 1. Another wireless device may be transmitting and overlap with the two subcarriers, and the transmitting UWB device suppresses the signal level in the notch frequency spectrum to avoid interfering with the other device. The signal level may be suppressed approximately −30 dB in notch frequency spectrum 600.

Unintended contributor 602 includes subcarriers 2 and 3 from band 1. The implementation of radio transmitter 500 creates a symmetric relationship such that unintended contributor 602 is symmetric with notch frequency spectrum 600 about the center frequency of band 1. Similarly, unintended contributor 604 is symmetric with notch frequency spectrum 600 about the center frequency of band 2. Unintended contributor 604 includes subcarriers 2 and 3 of band 3.

Data associated with unintended contributors 602 and 604 may be attenuated by an appropriate module in a baseband, such as null and attenuation block 402. When processing data intended for the band 1, null values may be used for subcarriers −3 and −2 of band 1. Data associated with subcarriers 2 and 3 of band 1 may be attenuated. Radio 500 does not produce any unintended contributors in band 2 for notch frequency spectrum 600. Data intended for band 2 may be unmodified. Band 3 includes unintended contributor 604. Data associated with subcarriers 2 and 3 in band 3 may be attenuated. Using the selectively attenuated data, I and Q signals are generated and passed to a radio transmitter.

Unintended contributors 602 and 604 may contribute different amounts to the signal level of notch frequency spectrum 600. The degree to which associated data is attenuated may reflect this. For example, it may be that unintended contributor 604 of band 3 contributes less to the signal level of notch frequency spectrum 600 compared to unintended contributor 602. Data associated with unintended contributor 604 may be attenuated to a lesser degree compared to data associated with unintended contributor 602.

The frequencies that are unintended contributors may also depend on the notch frequency spectrum. The following figure illustrates a notch frequency spectrum in the middle band of a band hopping sequence.

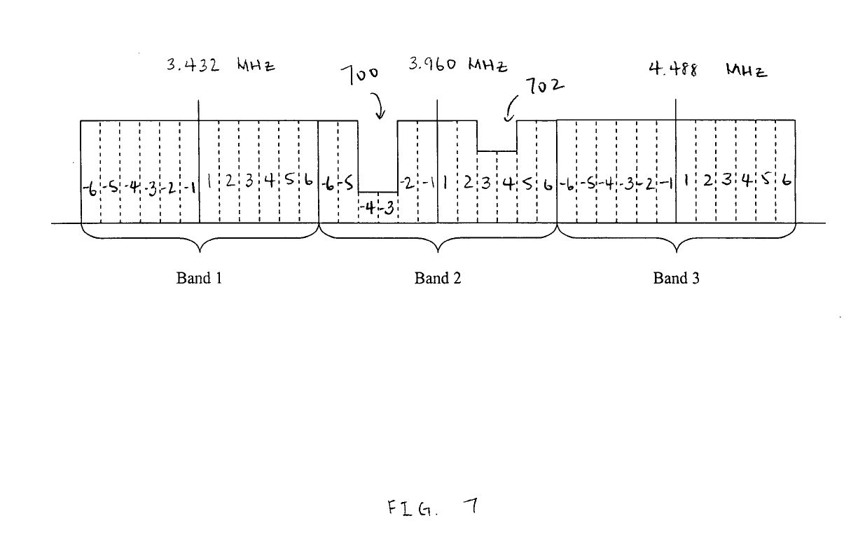

FIG. 7 is a diagram illustrating an embodiment of signal levels transmitted by a wireless device that selectively attenuates data to avoid a notch frequency spectrum in a middle band. In the example shown, the transmitting device is the same device as the previous example and uses the same bands for band hopping. However, another wireless device may have changed carrier frequencies to transmit in band 2, and notch frequency spectrum 700 includes subcarriers −4 and −3 of band 2. The same radio transmitter is used from the previous example and the same symmetry relationships may be used to determine the unintended contributors. Unintended contributor 702 includes subcarriers 3 and 4 of band 2, and is symmetric with notch frequency spectrum 700 about the center frequency of band 2.

Band 1 does not include an unintended contributor, so data intended for band 1 is not attenuated by a baseband. When processing data intended for band 2, a baseband uses null values for subcarriers −4 and −3 in band 2, and attenuates data associated with subcarriers 3 and 4 in band 2. Data associated with other subcarriers in band 2 are unmodified. Band 3 does not include an unintended contributor and data intended for band 3 is not attenuated.

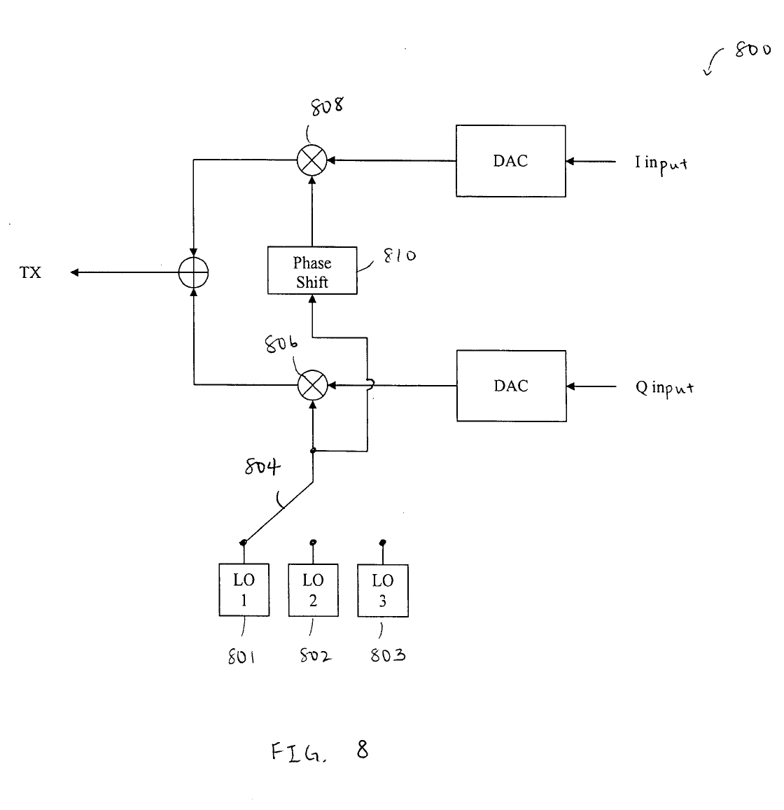

FIG. 8 is a block diagram illustrating an embodiment of a radio transmitter that uses a switch to select a local oscillator. In the example shown, radio transmitter 800 is one way of implementing of radio 304. Local oscillators (LO) 801-803 each correspond to a band used in band hopping. LO 801 is associated with band 1 and operates at 3.432 MHz, LO 802 is associated with band 2 and operates at 3.960 MHz, and LO 803 is associated with band 3 and operates 4.488 MHz.

Depending upon which band is in use at a particular time, switch 804 selects the corresponding local oscillator. When transmitting on band 1, switch 804 is configured to select LO 801. Switch 804 is configured to select LO 802 and LO 803 when transmitting on bands 2 and 3, respectively. Using the output of the selected LO, the analog I and Q signals are frequency shifted to the appropriate on-air band. Mixer 806 combines the analog Q signal and the output of the selected local oscillator from switch 804. Mixer 808 processes the analog I signal using the output from phase shift block 810. The outputs from mixers 806 and 808 are combined to generate the transmitted signal. In some embodiments, additional components such as filters and amplifiers may be included.

The implementation of radio transmitter 800 may result in different frequencies unintentionally contributing to the notch signal level compared to radio transmitter 500. Switch 804 may not be able to perfectly isolate each of the local oscillator outputs. As a result, a given subcarrier in one band may affect the same subcarrier in another band.

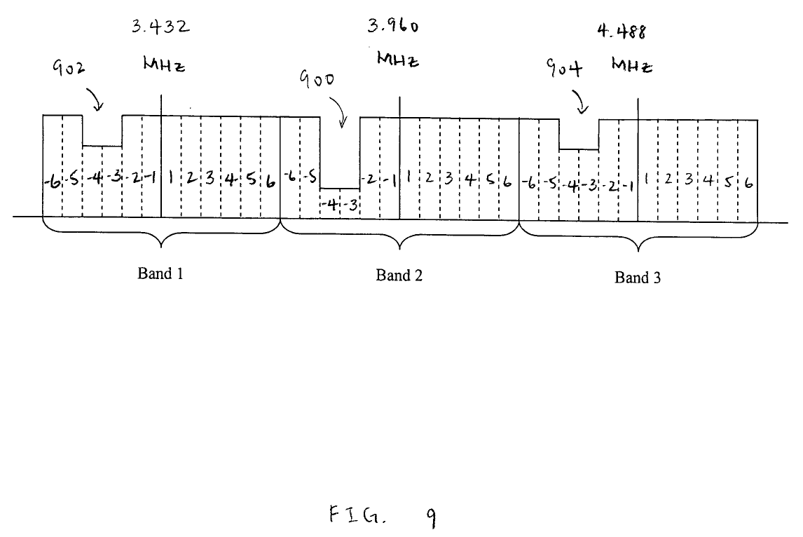

FIG. 9 is a diagram illustrating an embodiment of signal levels transmitted by a wireless device that selectively attenuates data associated with certain subcarriers for all bands. In the example shown, the transmitting wireless device includes radio transmitter 800. Radio 800 is a band hopping radio and alternates through (band 1, band 2, band 3) during transmission. At any given time, only one of the three bands is used and the illustrated spectrum is not a snapshot in time.

Notch frequency spectrum 900 includes subcarrier −4 and −3 in band 2. Another wireless device may be transmitting in notch frequency spectrum 900. Some noise may leak through switch 804 from the unselected local oscillators and affect the signal level of notch frequency spectrum 900. Null or attenuated data is therefore used in subcarriers −4 and −3 for all bands. Unintended contributor 902 includes subcarriers −4 and −3 in band 1 and unintended contributor 904 includes subcarriers −4 and −3 in band 3.

A baseband may selectively attenuate data associated with unintended contributors 902 and 904. When processing data intended for band 1, data in subcarriers −4 and −3 are attenuated, as is the case for data in subcarriers −4 and −3 when processing data intended for band 3. When processing data for band 2, null values may be used for subcarriers −4 and −3.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of processing data, comprising:
obtaining information associated with a notch frequency spectrum, wherein a notch signal level associated with the notch frequency spectrum is suppressed;
determining a second frequency spectrum based at least in part on the information associated with the notch frequency spectrum; and
attenuating data associated with the second frequency spectrum, wherein the notch signal level is based at least in part on the attenuated data.

2. A method as recited in claim 1, wherein a signal level associated with the second frequency spectrum contributes to the notch signal level.

3. A method as recited in claim 1, wherein attenuating data contributes to achieving a desired suppression level associated with the notch signal level.

4. A method as recited in claim 1, wherein:
attenuating data contributes to achieving a desired suppression level associated with the notch signal level; and
an image rejection mixer also contributes to achieving the desired suppression level.

5. A method as recited in claim 1, wherein determining the second frequency spectrum is further based at least in part on an implementation.

6. A method as recited in claim 1, wherein determining the second frequency spectrum is further based at least in part on an implementation, including a radio implementation.

7. A method as recited in claim 1, wherein the method is performed in the event at least one other wireless device is present.

8. A method as recited in claim 1, wherein attenuating data includes scaling.

9. A method as recited in claim 1, wherein attenuating data includes clipping.

10. A method as recited in claim 1 further including using at least one null value in association with the notch frequency spectrum.

11. A method as recited in claim 1, wherein the second frequency spectrum includes at least one subcarrier.

12. A method as recited in claim 1, wherein the data associated with the second frequency spectrum is attenuated prior to an Inverse Fast Fourier Transformation.

13. A method as recited in claim 1, wherein the data associated with the second frequency spectrum is attenuated to a programmable degree.

14. A method as recited in claim 1 further including:
determining a third frequency spectrum based at least in part on the information associated with the notch frequency spectrum; and
attenuating data associated with the third frequency spectrum, wherein the data associated with the second frequency spectrum is attenuated to a first degree and the data associated with the third frequency spectrum is attenuated to a second degree.

15. A method as recited in claim 1, wherein a first band includes the notch frequency spectrum and a second band includes the second frequency spectrum.

16. A method as recited in claim 1, wherein the second frequency spectrum includes a plurality of noncontiguous frequency ranges.

17. A system for processing data, comprising:
an interface configured to obtain information associated with a notch frequency spectrum, wherein a notch signal level associated with the notch frequency spectrum is suppressed; and
a processor configured to:
determine a second frequency spectrum based at least in part on the information associated with the notch frequency spectrum; and
attenuate data associated with the second frequency spectrum, wherein the notch signal level is based at least in part on the attenuated data.

18. A system as recited in claim 17, wherein a signal level associated with the second frequency spectrum contributes to the notch signal level.

19. A system as recited in claim 17, wherein attenuating data contributes to achieving a desired suppression level associated with the notch signal level.

20. A system as recited in claim 17, wherein the processor is configured to determine the second frequency spectrum further based at least in part on an implementation.

21. A system as recited in claim 17, wherein the second frequency spectrum includes at least one subcarrier.

22. A system as recited in claim 17, wherein the data associated with the second frequency spectrum is attenuated prior to an Inverse Fast Fourier Transformation.

23. A computer program product for processing data, the computer program product being embodied in a computer readable medium and comprising computer instructions for:
obtaining information associated with a notch frequency spectrum, wherein a notch signal level associated with the notch frequency spectrum is suppressed;
determining a second frequency spectrum based at least in part on the information associated with the notch frequency spectrum; and
attenuating data associated with the second frequency spectrum, wherein the notch signal level is based at least in part on the attenuated data.

24. A computer program product as recited in claim 23, wherein a signal level associated with the second frequency spectrum contributes to the notch signal level.

25. A computer program product as recited in claim 23, wherein attenuating data contributes to achieving a desired suppression level associated with the notch signal level.

26. A computer program product as recited in claim 23, wherein determining the second frequency spectrum is further based at least in part on an implementation.

27. A computer program product as recited in claim 23, wherein the second frequency spectrum includes at least one subcarrier.

28. A computer program product as recited in claim 23, wherein the data associated with the second frequency spectrum is attenuated prior to an Inverse Fast Fourier Transformation.
